(19) United States
(12) Patent Application Publication
(10) Pub. No.: US 2013/0339469 A1
(43) Pub. Date: Dec. 19, 2013

(54) SELF-REPLENISHING CACHES

(71) Applicants: Stephen M. Yolleck, Sunny Vale, CA (US); Deepa Ramachandran, Mountain View, CA (US)

(72) Inventors: Stephen M. Yolleck, Sunny Vale, CA (US); Deepa Ramachandran, Mountain View, CA (US)

(73) Assignee: MICROSOFT CORPORATION, Redmond, WA (US)

(21) Appl. No.: 13/525,407

(22) Filed: Jun. 18, 2012

(51) Int. Cl. G06F 15/167

(52) U.S. Cl. 709/213

(57) ABSTRACT

Various embodiments pertain to self-replenishing caches. In various embodiments, a cache on a client device automatically updates without intervention from a user and without data calls from the executable. In other words, the cache can be configured to automatically update without the executable retrieving the content from the content server and causing the content to be displayed to the user. For example, when the executable causes a different background image to be displayed each day, background images for days that a user did not interact with the executable can be cached and will be accessible to a user upon the user's next interaction with the executable. In various embodiments, the cache is configured to poll the content server on a periodic basis effective to retrieve a current version of the content.

### BACKGROUND

Various applications, also called executables, display content to a user via a client device. This content is retrieved from a remote content server accessed via a network. When the content to be displayed is updated, for example, on an hourly, daily or weekly basis, the executable retrieves the current content from the content server and causes it to be displayed to a user, and also frequently enables a user to view previous versions of content. In a server-side solution, when a user indicates a desire to access a previous version of the content (e.g., yesterday's content), the executable can retrieve the previous version of the content from the content server and cause it to be displayed to the user. When the user attempts to return to the current content, the executable again retrieves the current content from the server. However, the content is not available when the client device is offline, and retrieving the content versions from the content server can be repetitive and costly in terms of time and computational resources.

In order to enable offline access to the content and to increase response time, a copy of the content can be stored on the client device in a cache. The executable can retrieve the current content from the content server and cache the content (e.g., store a copy on the client device). Then, when a user indicates a desire to access that version of the content, the executable can retrieve the version of the content from the cache and cause it to be displayed to the user without requesting it again from the server. For example, when the user attempts to return to today's content after viewing yesterday's content, the executable can cause today's content to be displayed without re-requesting it from the server. However, prior versions of the content that were not cached (e.g., in the event that a user didn't view the content yesterday), are not available from the cache and will be retrieved from the content server upon a user's request to view the version.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments pertain to self-replenishing caches. In various embodiments, a cache on a client device automatically updates without intervention from a user and without data calls from the executable. In other words, the cache can be configured to automatically update without the executable retrieving the content to be displayed to the user from the content server. In various embodiments, the cache is configured to poll the content server on a periodic basis effective to retrieve a current version of the content.

In various embodiments, the cache is configured to maintain a pre-determined size or to remain below a pre-determined threshold. In some embodiments, upon reaching the pre-determined threshold, the cache is configured to evict the oldest entry so as to maintain content versions in a first-in-first-out fashion.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 is an illustration of an environment in an example implementation in accordance with one or more embodiments;

FIG. 2 is an illustration of a system in an example implementation showing FIG. 1 in greater detail in accordance with one or more embodiments;

FIG. 3 is an illustration of an environment in an example implementation in accordance with one or more embodiments;

FIG. 4 is a data flow diagram illustrating an example process for replenishing a cache in accordance with one or more embodiments;

FIG. 5 is a block diagram illustrating an example method for replenishing a cache in accordance with one or more embodiments;

FIG. 6 illustrates an example process for chaining cache requests in accordance with one or more embodiments; and

FIG. 7 illustrates an example computing device that can be utilized to implement various embodiments described herein.

### DETAILED DESCRIPTION

Overview

Various embodiments pertain to self-replenishing caches. In various embodiments, a cache on a client device automatically updates without intervention from a user and without data calls from the executable. In other words, the cache can be configured to automatically update without the executable explicitly requesting the content to be displayed to the user from the content server. For example, when the executable causes a different background image to be displayed each day, background images for days that a user did not interact with the executable can be cached and will be accessible to a user upon the user's next interaction with the executable. In various embodiments, the cache is configured to poll the content server on a periodic basis effective to retrieve a current and/or previous version of the content.

In various embodiments, the cache is configured to maintain a pre-determined size or to remain below a pre-determined threshold. In some embodiments, upon reaching the pre-determined threshold, the cache is configured to evict the oldest entry so as to maintain content versions in a first-in-first-out fashion. For example, the cache size can be set to “6”, indicating that the cache is configured to store content from the six previous days, and each day, the oldest content is removed from the cache to enable new content to be stored.

In the discussion that follows, a section entitled “Example Operating Environment” describes an operating environment in accordance with one or more embodiments. Next, a section entitled “Example Embodiments” describes various embodiments pertaining to self-replenishing caches. Finally, a section entitled “Example Device” describes an example device that can be used to implement one or more embodiments.

In the following discussion, an example environment is first described that is operable to employ the techniques described herein. Example illustrations of the various embodiments are then described, which may be employed in the example environment, as well as in other environments. Accordingly, the example environment is not limited to performing the described embodiments and the described embodiments are not limited to implementation in the example environment.

Example Operating Environment

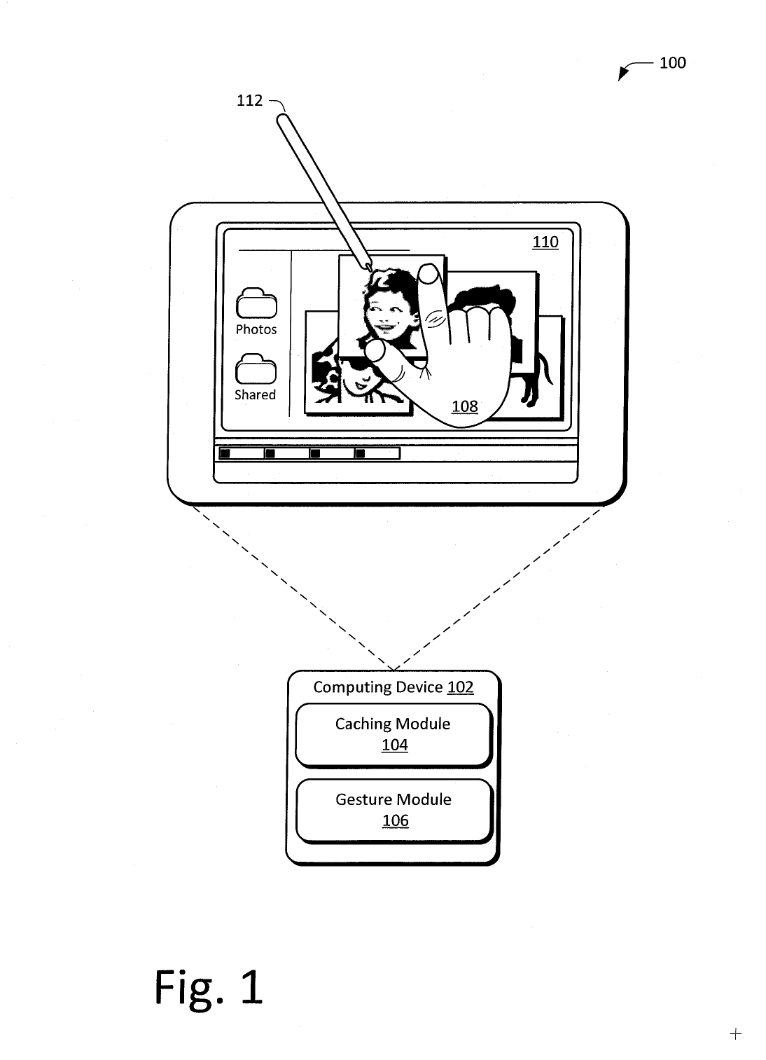

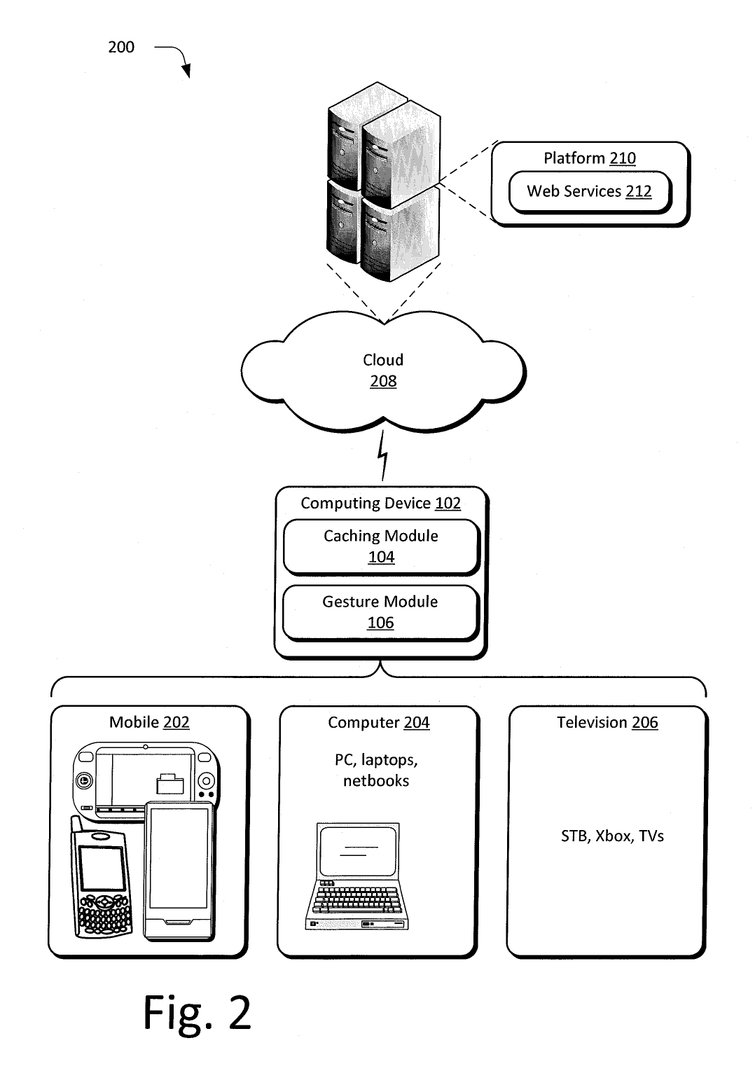

FIG. 1 is an illustration of an environment 100 in an example implementation that is operable to employ the techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, handheld game consoles). The computing device 102 also includes software that causes the computing device 102 to perform one or more operations as described below.

Computing device 102 includes a caching module 104 which can include a suitably configured cache and cache manager configured to cause a cache to store data, such as content displayed on a web page, to enable future requests for the data to be served faster than when the data is not stored in a cache. For example, caching module 104 can cause content for a web page or executable module that causes different content to be displayed to a user on a periodic basis, such as a different background on a daily basis, to be stored in a cache. When the content (e.g., background image) is stored in the cache, a subsequent request for the content can be fulfilled by the cache rather than being retrieved from a content server or other source for the content.

Caching module 104 is representative of functionality that enables the cache to be updated on an automatic basis (e.g., without action by the executable module) with updated or new content. For example, assume that a web page accessed by an executable module (e.g., a web browser) of a computing device includes a background image (e.g., content) that changes on a daily basis. When a user views the web page in the web browser, the user may desire to view the previous day's image (e.g., previous content). In various embodiments, caching module 104 has caused the cache to be automatically updated such that the previous day's image is already stored in the cache, regardless of whether the user viewed the web page in the web browser on the previous day. Therefore, the web browser does not need to request the previous day's image from the web page server, but can instead retrieve the content from the cache.

Accordingly, the caching module provides a means for content to be cached without user intervention or explicit data calls from the executable module utilizing the cached data. Cached content, including content that a user has not previously viewed, can be available to the executable module, and the user, in offline scenarios and can be rendered in a shorter period of time than non-cached content.

Computing device 102 also includes a gesture module 106 that recognizes gestures that can be performed by one or more fingers, and causes operations to be performed that correspond to the gestures. The gestures may be recognized by module 106 in a variety of different ways. For example, the gesture module 106 may be configured to recognize a touch input, such as a finger of a user's hand 108 as proximal to display device 110 of the computing device 102 using touchscreen functionality. Module 106 can be utilized to recognize single-finger gestures and bezel gestures, multiple-finger/same-hand gestures and bezel gestures, and/or multiple-finger/different-hand gestures and bezel gestures.

The computing device 102 may also be configured to detect and differentiate between a touch input (e.g., provided by one or more fingers of the user's hand 108) and a stylus input (e.g., provided by a stylus 112). The differentiation may be performed in a variety of ways, such as by detecting an amount of the display device 110 that is contacted by the finger of the user's hand 108 versus an amount of the display device 110 that is contacted by the stylus 112.

Thus, the gesture module 106 may support a variety of different gesture techniques through recognition and leverage of a division between stylus and touch inputs, as well as different types of touch inputs.

FIG. 2 illustrates an example system 200 showing the caching module 104 and gesture module 106 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of devices may be defined by physical features or usage or other common characteristics of the devices. For example, as previously described, the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks. For example, the caching module 104 may be implemented in part on the computing device 102 as well as via platform 210 that supports web services 212.

The gesture techniques supported by the gesture module may be detected using touchscreen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

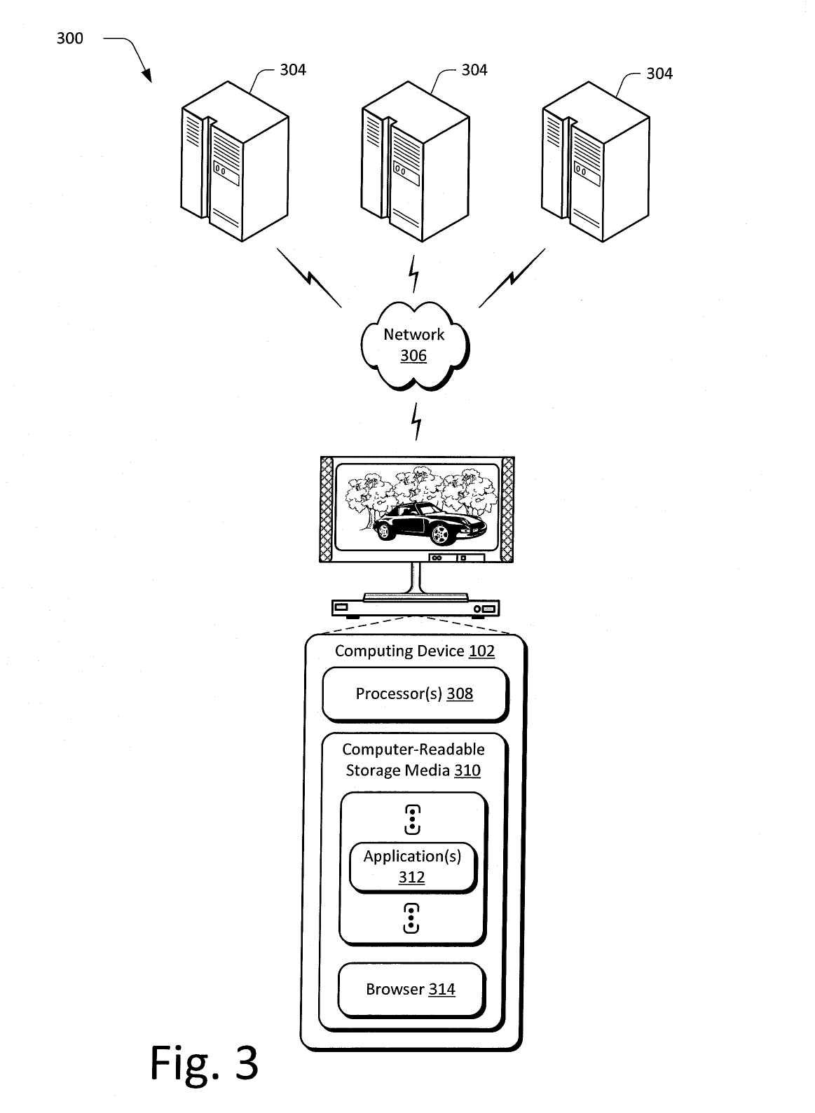

FIG. 3 illustrates an example environment 300 in which the computing device 102 is able to retrieve content from various content hosting servers 304 through network 306. In FIG. 3, the executable module utilizing the content is a browser rendering content on a web page, though it is to be understood that the browser is representative of any executable module that requests content from a content hosting server.

Computing device 102 is configured to receive content, such as web pages and images, from one or more content hosting server 304. Computing device 102 can include one or more processors 308 and computer-readable storage media 310. Computing device 102 can be embodied as any suitable computing device such as, by way of example and not limitation, a desktop computer, a portable computer, a netbook, a handheld computer such as a personal digital assistant (PDA), a cell phone, and the like, as described above and below.

Computer-readable storage media 310 includes one or more software applications, which can include various applications 312. Application 312 can be, for example, caching module or other software executable modules, integrated with or in addition to browser 314. Application 312 can be an executable module that utilizes content cached by caching module. Browser 314 can receive content from and send content to other servers, such as content hosting server 304, via network 306, such as the Internet. Such content can include any suitable type of content that can be received from and sent to websites hosted by servers. In various embodiments, browser 314 is configured to send a request for a web page to be displayed to a user. Browser 314 manages various events during the loading and rendering of the web page, including retrieving content included on the web page.

Content hosting server 304 hosts content to be loaded and rendered by browser 314. Various content items or portions of a web page can be provided to the browser 314 by one or more content hosting servers 304. Content items can include, by way of example and not limitation, images, videos, multimedia presentations, audio, text, advertisements, and the like, including combinations of various types of content. Content hosting server 304 is configured to store one or more content items and can transmit the content items through network 306 to the computing device 102. In various embodiments, one or more content items are included in the web page by including a uniform resource locator (URL) for the content item in the source code for the web page. When browser 314 processes the source code, such as via a parser and tree building module, the URL can direct the browser 314 to download the content item from content hosting server 304. In various embodiments, after the browser 314 has downloaded the content item from content hosting server 304, the caching module causes the downloaded content item to be stored in the cache of computing device 102.

In various embodiments, the caching module is configured to automatically update the cache, and when browser 314 processes the source code for the web page, the browser 314 can obtain the content item from the cache rather than downloading the content item from content hosting server 304.

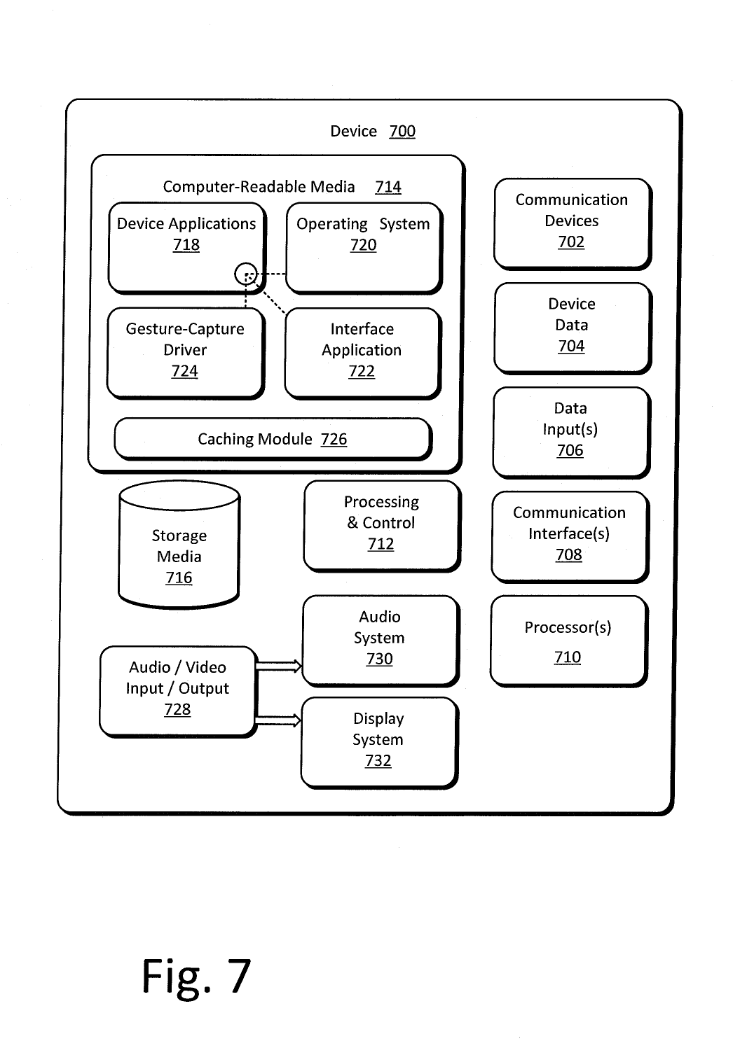

The computer-readable storage media included in each device or server can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 7.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer-readable memory devices. The features of the gesture techniques described below are platform-independent, meaning that the techniques may be implemented on a variety of commercial computing platforms having a variety of processors.

Having described an example environment, consider now a discussion of automatically caching content items in accordance with one or more embodiments.

### Example Embodiments

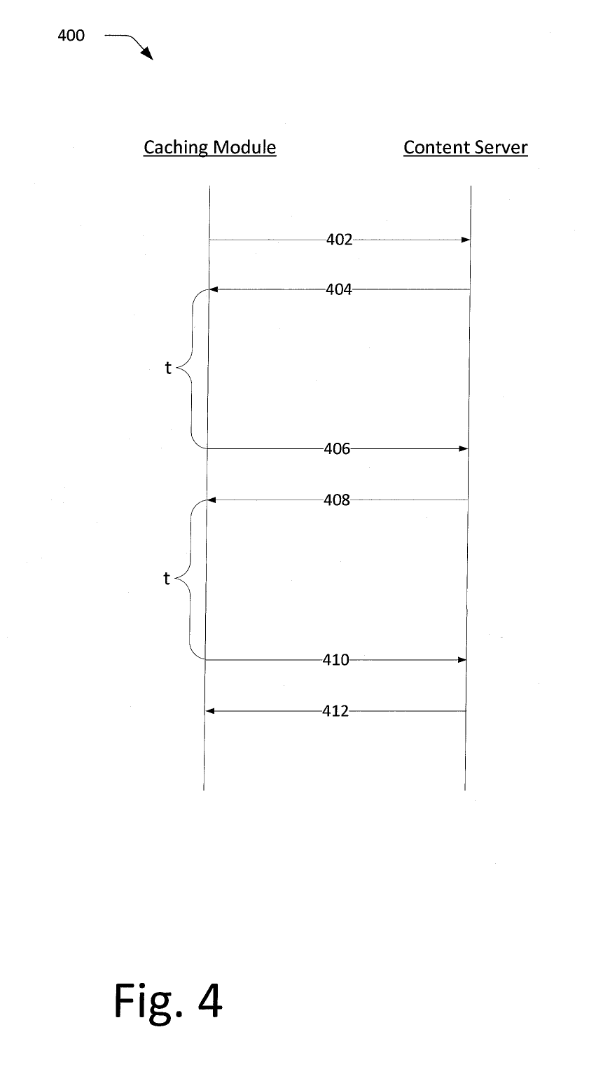

FIG. 4 is a diagram of an example process 400 for automatically caching content items in accordance with one or more embodiments. In FIG. 4, vertical lines represent the caching module and content server, although in various embodiments, other components can be additionally or alternatively involved in the process 400.

In various embodiments, a caching module is employed to cause content from the content server to be retrieved and stored in the cache. The caching module can manage one or more caches, and can manage the content for one or more executable modules retrieved from one or more content servers. Each cache is configured with a variety of parameters, including but not limited to a period of time between cache refreshes (“t”) (e.g., daily, weekly, etc.), a URL used to obtain content for the current period, URL parameters to obtain content for the next period, URL parameters to obtain content for the previous period, and a cache size (e.g., a number of entries retained). In various embodiments, data can be obtained via means other than a URL. In such embodiments, the location for the current period as well as parameters to obtain content for the next and previous periods can be substituted for the URL and URL parameters. The particular configuration of the cache may vary depending on the specific embodiment implemented.

At 402, the caching module transmits a request for the content for the current period to the content server. This can be performed in any suitable way. For example, the caching module can transmit a request to the content server via a network, such as network 306. When a cache is initially used, the caching module primes the cache with the current period's entry and backfills the cache with previous periods until the cache size is met. In other words, if a cache has not been previously used, the request can be a request for content for previous periods in addition to the current period.

At 404, the content server transmits the content for the relevant period or periods to the caching module. This can be performed in any suitable way. For example, the content server can send content for the current period to the caching module via the network 306. In various embodiments, the caching module causes the cache to store the content. When content for the current period is stored in the cache, the content corresponding to the oldest entry in the cache is evicted. In other words, content entered into the cache is evicted in a first-in first-out fashion.

After a period of time t passes, at 406, the caching module transmits a request for the content for the new current period to the content server. Responsive to receiving the request, at 408, the content server transmits the content to the caching module. Again, the caching module causes the cache to store the content and the content corresponding to the oldest entry in the cache is evicted. After the period of time t passes, at 410, the caching module transmits a request for the content for the new current period to the content server and, at 412, the content server transmits the content to the caching module.

In various embodiments, the caching module is operative independent of the executable that utilizes the cached content. For example, assume the caching module manages content entries for a browser or other executable module. The caching module can operate when the browser or other executable module is not operating such that when the browser or other executable module is launched, the content can be displayed without delay.

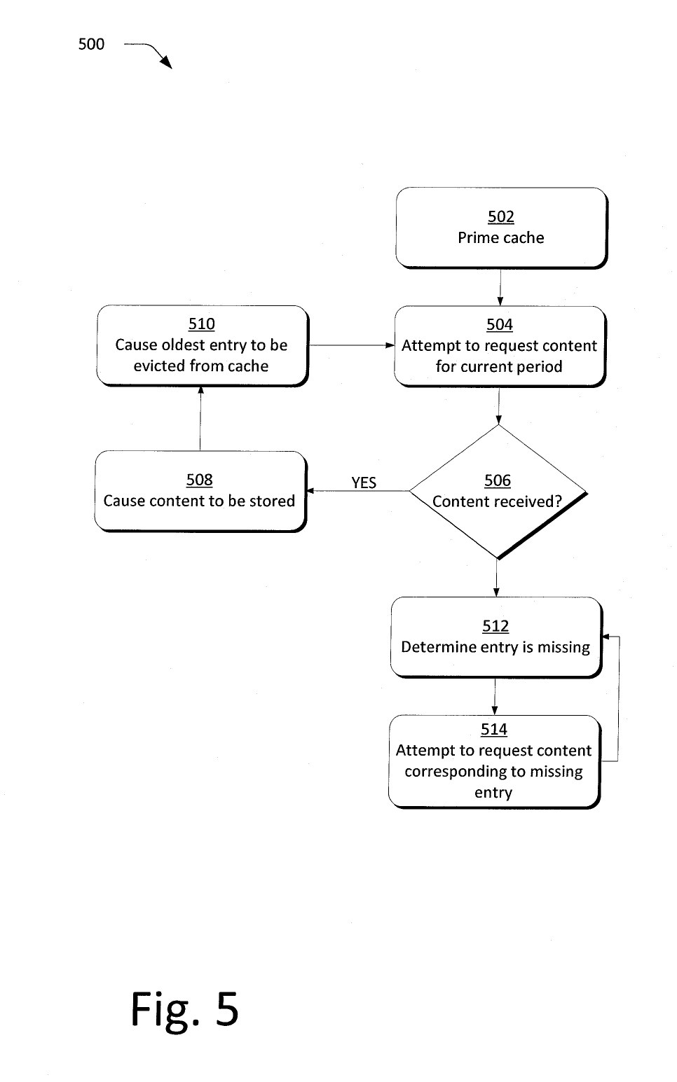

The caching module is also configured to fill in any gaps that may occur. For example, assume a content entry for at least one period is missing. This can be the result of various circumstances, such as a failed transmission of a request (e.g., the computing device does not have a network connection or the content server is unavailable) or a failed transmission of content (e.g., the content is not transmitted by the content server or received by the caching module), or if the user did not use the computer for several days. When the caching module detects a missing entry for one or more periods, it transmits a request for the missing content to the content server. The request can be transmitted in addition to the request for content for a new current period or can be transmitted upon detection of the missing entry. FIG. 5 depicts much of process 400 in a different format, and more clearly illustrates how the caching module may fill gaps in content.

FIG. 5 illustrates an example process 500 for automatically caching content items in accordance with one or more embodiments. The process can be implemented in connection with any suitable hardware, software, firmware, or combination thereof. In at least some embodiments, the process can be implemented in software. For example, the process can be implemented by caching module 104.

Block 502 primes one or more caches. This can be performed in any suitable way. For example, caching module 104 can prime the cache(s) with the current period's entry and can backfill the cache with previous periods until the cache size is met.

Block 504 attempts to request content for the current period. This can be performed in any suitable way. For example, caching module 104 can transmit a request for content to a content server via network 306. Block 506 determines whether the content was received.

If the content was received, block 508 causes the content to be stored in the cache, and block 510 causes the oldest entry to be evicted from the cache. This can be performed in any suitable way. For example, the entry corresponding to the earliest period can be removed from the cache. When the appropriate period of time has passed, the process returns to block 504 and attempts to request content for the new current period.

Block 512 determines that the entry is missing. As described above, a missing entry may result from a failed attempt to request the content or a failure to receive the content, or the computing device 102 has not been attached to the network for several “t” time periods. Block 514 attempts to request the content corresponding to the missing entry. This can be performed in any suitable way. For example, the missing content may be requested upon determination that the entry is missing, or it may be requested along with (e.g., substantially simultaneously with) a request for content for a new current period (e.g., with a request from block 504). In some embodiments, if multiple entries are missing, a single request for all missing entries can be sent, while in other embodiments, each missing entry is requested individually from the server. In various embodiments, the process returns to block 506 to determine whether the missing content entries were received.

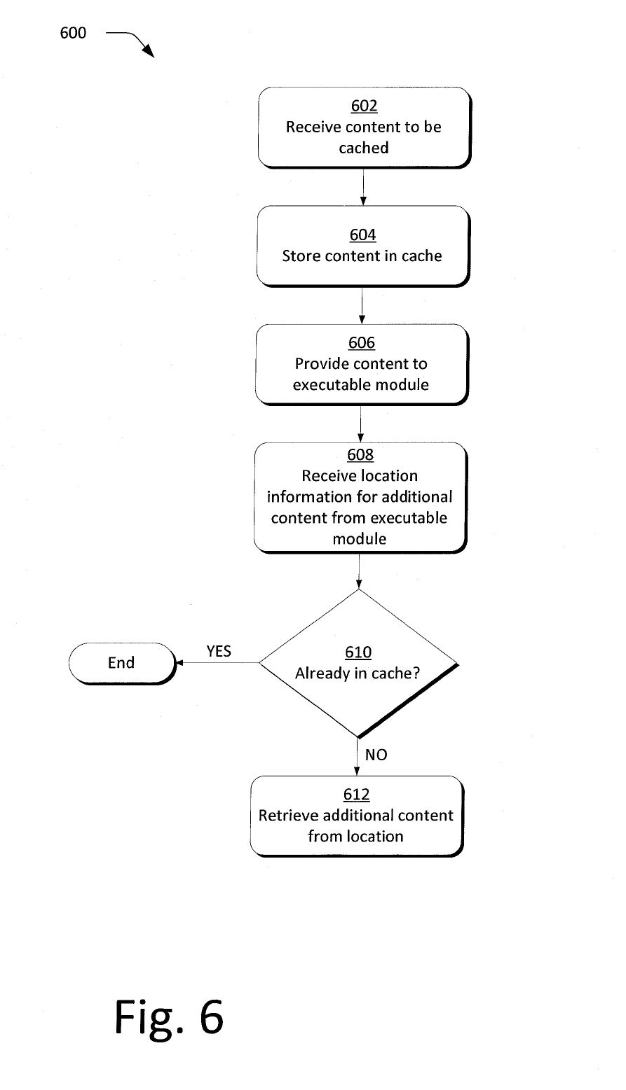

In various embodiments, in addition to fetching content from the server and caching it, the caching module can be configured to transmit additional requests to the server based on the received content. FIG. 6 illustrates an example method 600 of chaining cache requests. The method can be implemented in connection with any suitable hardware, software, firmware, or combination thereof. In at least some embodiments, the method can be implemented in software. For example, the method can be implemented by caching module 104.

Block 602 receives content to be cached. This can be performed in any suitable way. For example, content, such as a news story, can be received from a content server in response to a request for content for a current period of time. Block 604 stores the content in the cache. This can be performed in any suitable way.

Next, block 606 provides the content received by block 602 to an executable module. This can be performed in any suitable way. For example, code corresponding to the content can be provided to the executable module (e.g., application) that will utilize the cached content at this time. The executable module can also elect to wait until the chained requests have completed.

Block 608 receives location information for additional content from the executable module. This can be performed in any suitable way. For example, the cache module 104 can parse the response corresponding to the content and identify additional URLs contained in the code that correspond to additional content. For example, a news story received by block 602 can include one or more images that are incorporated into code for the story using a URL for a location of the image. The location information for the additional content may be provided in a form other than the use of a URL, depending on the particular embodiment. For example, if content received by block 602 is an XML file, an XPath string can be extracted to enable the additional content to be retrieved by the caching module.

In various embodiments, block 606 provides the received content to a plug-in or other application programming interface (API) for the cache module 104 and block 608 receives location information for additional content from the plug-in. In these embodiments, the plug-in can be configured to process the response corresponding to the content.

Block 610 determines whether the additional content is already in the cache. If it already exists, the process ends. If, however, the additional content is not already in the cache, block 612 retrieves the additional content from the location. This can be performed in any suitable way. For example, the caching module can request the content from a content server hosting the content, as identified by the URL.

Having described an example implementation, consider now a discussion of an example device that can be utilized to implement the embodiments described above.

Example Device

FIG. 7 illustrates various components of an example device 700 that can be implemented as any type of portable and/or computer device as described with reference to FIGS. 1 and 2 to implement embodiments of the caching module described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable or readable instructions to control the operation of device 700 and to implement the embodiments described above. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 718 also include any system components or modules to implement embodiments of the techniques described herein. In this example, the device applications 718 include an interface application 722 and a gesture-capture driver 724 that are shown as software modules and/or computer applications. The gesture-capture driver 724 is representative of software that is used to provide an interface with a device configured to capture a gesture, such as a touchscreen, track pad, camera, and so on. Alternatively or in addition, the interface application 722 and the gesture-capture driver 724 can be implemented as hardware, software, firmware, or any combination thereof. In addition, computer-readable media 714 can include a caching module 726 that functions as described above.

Device 700 also includes an audio and/or video input-output system 728 that provides audio data to an audio system 730 and/or provides video data to a display system 732. The audio system 730 and/or the display system 732 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 730 and/or the display system 732 are implemented as external components to device 700. Alternatively, the audio system 730 and/or the display system 732 are implemented as integrated components of example device 700.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

What is claimed is:

1. A computer-implemented method comprising:
transmitting, to a content server, a request for content for a current period of time;
receiving, from the content server, content for the current period of time; and
causing the content to be stored in a cache;
wherein transmitting the request for the content is configured, at least in part, to occur when an executable module utilizing the content is not being executed.

2. The computer-implemented method of claim 1, further comprising:
responsive to determining a pre-determined period of time has passed, transmitting a subsequent request for content for a new period of time to the content server.

3. The computer-implemented method of claim 2, wherein the pre-determined period of time is a day or less.

4. The computer-implemented method of claim 2, wherein the pre-determined period of time is a week or less.

5. The computer-implemented method of claim 1, the content comprising one or more of an image, a video, a multimedia presentation, audio, text, or an advertisement.

6. The computer-implemented method of claim 1, further comprising:
providing code corresponding to the content to an executable module;
receiving, from the executable module, a location of additional content, the location extracted from code corresponding to the content; and
retrieving the additional content from the location.

7. The computer-implemented method of claim 6, receiving a location comprising receiving a URL from which the additional content can be retrieved.

8. The computer-implemented method of claim 6, receiving a location comprising receiving an) XPath string from which the additional content can be retrieved.

9. One or more computer-readable storage media comprising instructions that are executable to cause a device to perform a process comprising:
attempting to request, from a content server, content for a current period of time;
determining whether the content for the current period of time was received responsive to said attempting;
responsive to determining that the content was received, causing the content to be stored in a cache; and
responsive to determining that the content for the current period was not received, determining that a cache entry is missing and attempting to request, from the content server, content corresponding to the missing cache entry.

10. The one or more computer-readable storage media of claim 9, the process further comprising:
responsive to causing the content to be stored in the cache, causing an entry to be evicted from the cache, wherein the entry comprises content corresponding to an earlier period of time.

11. The one or more computer-readable storage media of claim 9, the process further comprising:
responsive to determining a pre-determined period of time has passed, transmitting a subsequent request for content for a new period of time to the content server.

12. The one or more computer-readable storage media of claim 11, wherein transmitting the subsequent request for content for the new period of time comprises transmitting the subsequent request for content for the new period of time at the same time as attempting to request content corresponding to the missing entry.

13. The one or more computer-readable storage media of claim 9, determining that an entry is missing comprising determining that a plurality of entries are missing.

14. A device comprising:
one or more processors;
one or more computer-readable storage media;
a caching module embodied on the one or more computer-readable storage media and configured to be executed under the influence of the one or more processors to at least:
transmit, to a content server, a request for content for a current period of time;
receive, from the content server, content for the current period of time;
cause the content to be stored in a cache; and
transmit, on a periodic basis, subsequent requests for content for a period of time; and
an executable module embodied on the one or more computer-readable storage media and configured to utilize content stored in the cache;
wherein the caching module is configured to transmit requests for content and receive content while the executable module is not being executed.

15. The device of claim 14, the caching module being further configured to:
determine that one or more content entries are missing from the cache; and
attempt to retrieve the one or more content entries from the content server.

16. The device of claim 14, wherein the caching module is configured to periodically transmit subsequent requests by transmitting subsequent requests on a daily basis.

17. The device of claim 14, wherein the caching module is configured to periodically transmit subsequent requests by transmitting subsequent requests on a weekly basis.

18. The device of claim 14, wherein the caching module is configured to periodically transmit subsequent requests by transmitting subsequent requests on about an hourly basis.

19. The device of claim 14, the caching module being further configured to:
provide code corresponding to the content to the executable module;
receive, from the executable module, a location of additional content, the location extracted from code corresponding to the content; and
retrieve the additional content from the location.

20. The device of claim 19, wherein the location comprises an XPath string from which the additional content can be retrieved.
